(19) United States
(12) Patent Application Publication
(10) Pub. No.: US 2007/0266236 A1
(43) Pub. Date: Nov. 15, 2007

(54) Secure network and method of operation

(76) Inventor: Nathan von Colditz, Lake Oswega, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/799,383

(22) Filed: Apr. 30, 2007

Related U.S. Application Data
(60) Provisional application No. 60/798,759, filed on May 9, 2006.

(51) Int. Cl. H04L 9/00

(52) U.S. Cl. 713/153

(57) ABSTRACT

An approach for securely establishing and operating a network is presented. The approach uses a direct connection authentication and a network establishment process where two devices can agree on network properties and characteristics to follow when operating as a network. The approach can also negotiate and follow a predetermined sequence of changing network characteristics and can provide obscurity null data to increase network security.

The present application claims priority to provisional patent application Ser. No. 60/798,759, titled “Concurrence Networks—Unique Methods for Creating Individual, Secure, Private Peer-To-Peer Networks” listing Nathan von Colditz as the sole inventor, filed on May 9, 2006, the entire contents of which are hereby incorporated by reference.

### FIELD

The present application relates to secure network establishment and operation.

### BACKGROUND

Computing and communications networks are increasingly common and users can access these networks from virtually anywhere with a range of devices including laptop computers, cell phones, personal digital assistants, cameras, etc. One example network that users may access is the global network of computing and communications networks called the Internet. Some public access points allow a user a temporary access to the Internet, such as at a coffee shop, an air port, a train station, etc.

Network security is an important consideration as these computing and communications networks and access points are increasingly used. Unfortunately, the more secure methods of operating a network are typically the most time consuming to establish and require a defined preexisting relationship, resulting in limited security in places where users do not need permanent network access.

In one example, Virtual Private Networks (VPNs) may use various types of encryption and cryptography to create secure networks. A VPN is created when a user, or a preinstalled program, authenticates with a VPN originator utilizing a combination of password authentication, secure certificates, number generating devices for password authentication, EP address authentication, key phrases, and/or other security schemes. Although fairly secure, a VPN has inherent requirements that do not mesh well with networks that are more community based. Not only do VPNs require centralized authentication to a network operator, but they also require either a password based, certificate based, and/or hardware based form of authentication. In combination with any required software to operate a VPN, the trade-off to achieve a VPN level of security is often too inconvenient for a roaming user or at public access points.

Wired Equivalent Privacy (WEP) and similar network security approaches may provide less security than a VPN, but still often require a nontrivial setup time to establish and distribute security keys, tokens, or some form of password authentication. Additionally, WEP uses a single key across a class of users. If the security key is changed, every end user must reconfigure their network connections according to the new security key. The common result of the inconvenience to establish even a remotely secure network is that roaming users typically default to a low level of security or no security at all. What is needed is a network security system and method that is both trustworthy and convenient to establish that offers a satisfactory level of security.

### SUMMARY

One example approach to overcome at least some of the disadvantages of prior approach includes connecting a first device with a second device using a secure first connection, generating at least one digital signature for the first device and second device to authenticate with each other, negotiating network characteristics between the first device and the second device based on the networking capabilities of the first device and second device, wherein the network characteristics contain at least one of an encryption type, an encryption key, a service set identifier and a network channel, and establishing a network between the first device and the second device over a second connection based on the negotiated network characteristics.

In a second approach, also described herein, the above issues may be addressed by a system with at least a first network capable device comprising a first communication link to provide a secure connection with a second device, and a processor coupled with the first communication link, the processor to generate a digital signature for the second device to authenticate the first network capable device negotiate network characteristics with the second device based on the networking capabilities of the two devices, wherein the network characteristics contain at least one of an encryption type, an encryption key, a service set identifier and a network channel, and establish a network between the devices over a second communication link coupled with the processor, wherein the network between the devices is configured based on the negotiated network characteristics.

The present description provides several advantages. In particular, the system and method simplify establishment and operation of a secure network. Another advantage is reducing the configuration steps by an end user of a secure network. Another advantage is allowing a plurality of secure networks each consisting of two devices operating under a common access point or physical network. And yet another advantage is a multiple layer security scheme that requires simultaneous efforts at two different security measures in order to defeat the multiple layer security scheme. The above advantages and other advantages, and features of the present description will be readily apparent from the following Detailed Description when taken alone or in connection with the accompanying drawings.

### DESCRIPTION OF THE DRAWINGS

FIG. 1 is a flow diagram of illustrating an example network establishment method.

FIG. 2 is a schematic diagram of an example secure network.

FIG. 3 is flow diagram illustrating a matrix transformation.

FIG. 4 is a flow diagram illustrating a multilayered approach to network security.

FIG. 5 is a diagram illustrating an embodiment device that can operate in a network as described herein.

### DETAILED DESCRIPTION

In the following description, various aspects of a command controller will be described. Specific details will be set forth in order to provide a thorough understanding of the present disclosure. However, it will be apparent to those skilled in the art that the present invention may be practiced with only some or all of the described aspects of the present disclosure, and with or without some or all of the specific details. In some instances, well-known features may be omitted or simplified in order not to obscure the present invention. Repeated usage of the phrase “in one embodiment” does not necessarily refer to the same embodiment, although it may.

Embodiments herein provide an approach for establishing and using secure networks between devices. Secure networks may be developed between devices according to device capabilities and may be established over a trusted connection to be utilized over a separate connection or path between the devices. Some embodiments may change network characteristics to increase security, may provide null data to discourage simple decryption or deciphering of secure communications, or may even layer multiple approaches to enhance network security.

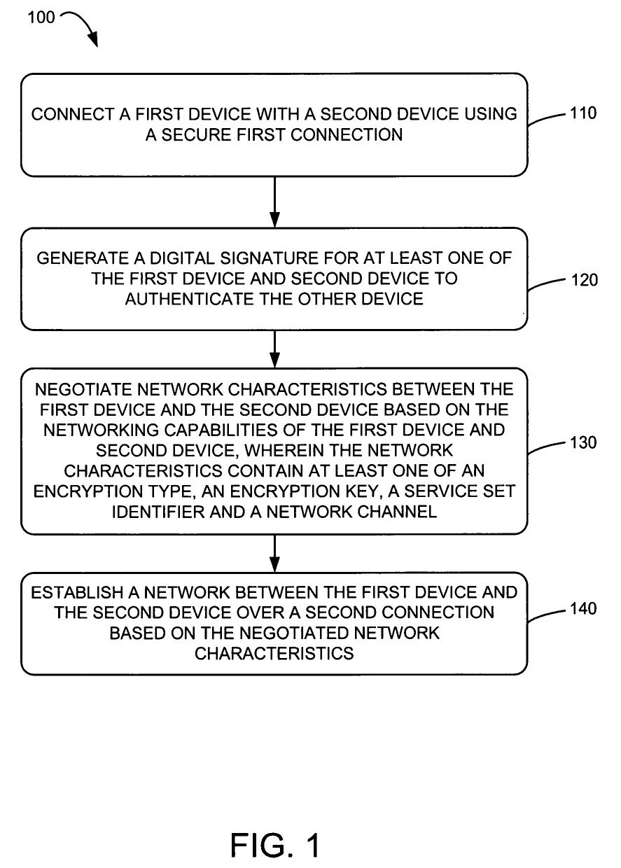

FIG. 1 is a flow diagram of illustrating an embodiment network establishment method 100. According to block 110, method 100 can connect a first device with a second device using a secure first connection. During network establishment, devices may operate in a host/client relationship, in a peer-to-peer relationship, etc., but are not restricted to a particular relationship. Secure first connections may include direct hard wired connections such as a USB cord connection, or a direct wired network connection; a direct line of site connection such as through infrared ports; or third-party authenticating devices such as a USB key, Smart Card, or a SIM card, as examples. In embodiments where two devices operate in a peer-to-peer relationship, a client may be used on either device to allow method 100 to establish a secure network. Furthermore, these embodiments may exchange an encrypted signature to allow each device to communicate with the other peer and verify authenticity. In host/client embodiments, the host may pass an encrypted connection string to the client device, which the client device could use to connect and authenticate with the host. The present embodiment functions as a ‘push architecture’ which requires a client to use a connection string.

In block 120, method 100 then can generate a digital signature for at least one of the first device and second device to authenticate the other device. The first and second device can also negotiate network characteristics based on the networking capabilities of the first device and second device as is illustrated in block 130. In some embodiments, the network characteristics may contain an encryption type, an encryption key, a service set identifier and a network channel, any combination thereof, or even other network characteristics that may be used to describe and define the securely transmitted data between two devices. In embodiments using a third-party device, the device would carry a pre-defined network description that may be used where a second device would have the choice to either accept or reject as opposed to negotiating network characteristics. In block 140, the method can establish a network between the first device and the second device over a second connection based on the negotiated network characteristics. In one example, the first connection may have security features and/or functions different from those of the second connection. For example, the first connection may provide a first base level of security and the second connection may provide a second, lower, base level of security. For example, a first connection may be wired, and the second connection wireless, where the wireless connection, even with available security functions, still provides a base level of security lower than a direct wired connection. However, by using and/or relying on information passed over the first connection to establish and maintain the second connection, the second connection may be able to provide overall effective security levels above its base second level, and even approach the first base level of security.

Method 100 combines privacy, security, and ease of use by modifying access credentials and creating a security and privacy layer surrounding the access credentials in order to create a secure network communication unique to each peer-to-peer relationship between devices in the network. Therefore, method 100 simplifies establishment of a secure network and can provide acceptable levels of security. Method 100 is not restricted to a certain type of network, but may be used in public access networks, business, academic and government applications, for roaming users, a peer-to-peer network, in wireless or wired networks, in private connections between devices, etc.

Furthermore, method 100 simplifies network establishment for the end user by providing an automated approach without a user needing to manually create a network or authenticate to a network in use. In some embodiments, method 100 may establish a secure network where an accessing device is provided restricted access, for example a pass-through access to a pre-identified list of network devices (Internet, internal devices, printers, etc.). There are multiple approaches for network generation. For example, a network may be automatically created, a limited set of connections may be allowed, a user can be prompted before creating a network, an access control list (ACL) can be used that allows only certain computers to automatically generate a network, etc.

Method 100 may be particularly suited to networks where control can be administered via the technologies available through VPNs, authentication, or other methods used to secure corporate networks and very private networks. For example, when network administrators desire to keep a network secure using encryption and access credentials, an end user is typically granted short term access to the networks. Short term access requires a certain amount of network administration overhead for create a network account, provide network authentication and access credentials, and establishment of the network using WEP keys, passwords, etc. Therefore an automated method to provide a sufficient level of security in a peer-to-peer network format can ease the administrative burden on a network administrator. In some embodiments, method 100 may establish a traceable, auditable, and non-transferable relationship to establish trust between two devices wherein each device or user agrees with the relationship.

In some embodiments, after a secure network is created using a direct communication between two devices in block 110, the two devices may create a network using standard communications protocols having built in layers of security. Independent of other security or encryption, the two devices may also generate and use a data transform to add null data to communications between the devices, wherein upon receipt of these communications, the second device strips the null data and processes the communication according to any negotiated network characteristics in block 130. An example data transform is a steganographic transformation that obscures an intended communication in a larger set of data. Some embodiments may use a combination of steganography and encryption, and even other security or privacy approaches, to add more layers of security for communications between two devices. The secure network between the two devices may be over a separate connection than the direct communication in block 110, or may be over the same connection as the direct communication. Some embodiments may comprise operating a network that was established in the manner of method 100.

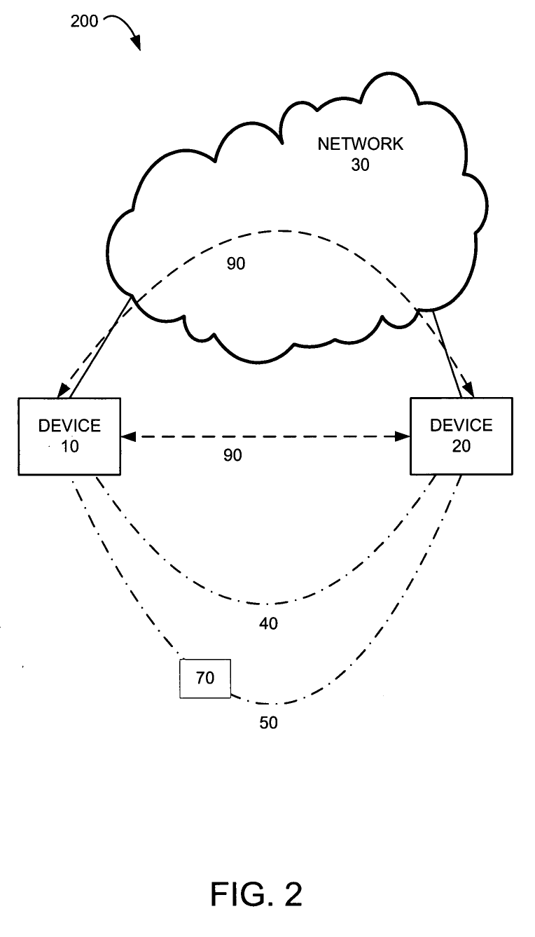

FIG. 2 is a schematic diagram of an example network 200. In this example, a network 30 is coupled to both a first device 10 and a second device 20. Device 10 and device 20 may first be coupled using a secure first connection 40 or a secure first connection 50. The first secure connection 40 may be a direct connection and first secure connection 50 may be a connection using a third party authentication device 70. In some embodiments, authentication device 70 may comprise two separate devices. In this example, authentication device 70 may function as a direct connection during establishment of a secure network and then be separated to allow devices 10 and 20 to communicate over a secure peer-to-peer connection 90 communicating through a separate connection such as network 30. After device 10 and device 20 authenticate over a first secure connection, they can establish a secure peer-to-peer connection 90 either through network 30 or through some other communication channel. The following disclosure will illustrate a manner to establish secure channels between device 10 and device 20 as well as a manner of operation of the secure channel.

In an example peer-to-peer network configuration, the peer devices 10 and 20 may both support wireless modes IEEE 802.11A and 802.11G. Device 10 may specify an 802.11G operation mode, which device 20 can then accept as a network configuration. The two devices can then generate an encryption type and encryption keys for the network, decide on an SSID, select a network channel, etc. According to the present embodiment, the two devices can then be presented with a password that they will use to connect to the each other. This password may be used during network establishment in order to authenticate each another. In some embodiments, the password can be delivered to an end user through a user interface (UI) of a software client, allowing the end user to provide the password to a peer once a secure network is established.

Devices 10 and 20 may configured to operate in a host and client network. In some embodiments, the host 10 may be preconfigured to allow a subsequent wireless connection 90 if the user/client establishes the network through a direct connection such as secure first connections 40 or 50. After the client device 20 is coupled to the direct connection, it is prompted to setup a secure network. The host 10 may then configure encryption types, encryption keys, a network channel SSID, etc., and present the client with a password for authentication when the client connects to the network 90 according to the configuration selected by the host.

According to some embodiments, a host 10 may require immediate activation of a wireless network while the client device 20 is directly connected. In another embodiment, the host can allow the client device to disconnect from the current session and then reconnect at a later time. In some embodiments, host 10 may permit a connection from the client for only a specific period of time, at specified times, for a specified number of uses, under certain access privileges, etc.

Some embodiments may provide additional forms of authentication to first secure network 40 or 50. For example, the two devices may not only generate keys to be used in authentication, they may also generate any network characteristics which are then both required to establish the network 90. Therefore, to establish a network between two devices that are not directly authenticated, the devices have a two factor authentication requiring something the device has (keys) and something the device knows (negotiated or assigned network configuration). In embodiments where the secure peer-to-peer connection 90 requires the two devices to be directly connected for network establishment, the connection state may be considered a third factor of authentication.

After the network configuration is generated and passed between peer devices 10 and 20 over a first secure channel 40, the devices may establish a secure peer-to-peer connection 90. At this point, the network can then be enabled for use.

In some embodiments, authentication may require a user or device 10 trying to establish a secure peer-to-peer connection 90 to know the properties of the network that were generated during a direct connection. After the device is connected, digital signatures can be compared to authenticate the user or device. Next, the user or device 10 will enter an access password, a username and password, an actual USB key, a SIM-card, etc. In some embodiments, once the device satisfies these criteria, the host or peer may also require the use of a communication scheme that dictates how the computers must communicate through the already encrypted tunnel.

Some embodiments institute a certain number of attempts for each authentication procedure. For example, aspects of the secure peer-to-peer connection 90 that are expected to be automatic such as the end user configuration and the digital signature may provide a limit on the number of allowed configuration attempts before the secure peer-to-peer connection 90 is disabled or prevented from being established. Other aspects such as password entries may allow multiple attempts to authenticate and establish the secure peer-to-peer connection. In some embodiments, while the user connects through the direct connection in block 110, the user can copy a password and enter it into a client software package so that when the secure peer-to-peer connection 90 is created the network password is passed automatically to the network host or peer. Once the device is connected and proper credentials are authenticated, a host or peer can grant a user or device access to the secure network. Some embodiments may establish several levels of users as defined by an administrator. For example, users may be separated into ‘known’ users and ‘guest’ users. The administrator can then limit access privileges based on user level.

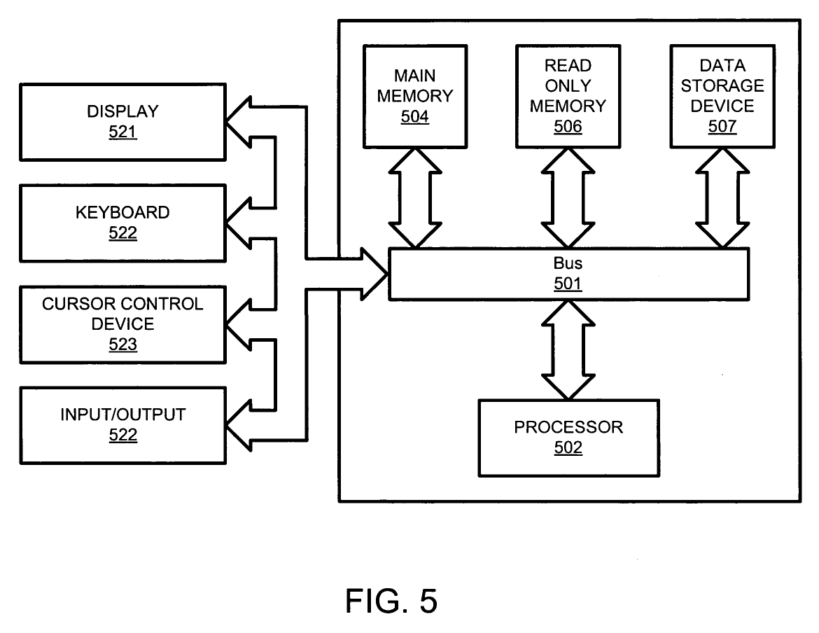

Some embodiments may function as a software client that can be installed on a device prior to generation of a secured network. In this example, the software client may be able to define and create secure peer-to-peer connections 90, decrypt and encrypt communication steams using null data encryption strings, configure a network capable device (wired or wireless) to determine network characteristics, and then once generated, maintain and administer an active communication. By installing the software, a user may be guided through a setup process followed by the software package assuming control of the network and then automatically generate it and connect the user or device to the network. Other embodiments may be in firmware, on a machine-readable medium, as described below in reference to FIG. 5.

A secure peer-to-peer network 90 may be established to provide an adaptable network. For example, after network generation and establishment over a first secure channel 40, the network may change network characteristics to provide an additional layer of security over a secure peer-to-peer connection 90. Some embodiments may reestablish network keys, determine new SSIDS, etc. In some embodiments, to reestablish a network after an original connection is lost or terminated, the user device may have to reconnect through the direct connection such as first secure channel 40 or 50. The new network characteristics may be determined at the initial network generation and establishment phases or they may be configured after the network is operational and exchanged between the devices. Other embodiments may preserve the network configuration and grant access after authentication of the user or device.

In some embodiments additional security may be provided by adding null data to communications between devices using a data transformation to provide a layer of security, as will be explained below in more detail. The null data be operate as a stand alone algorithm, or may use it in combination with other security approaches and encryption. The addition of null data to encrypted data operates by obscuring the true data being sent, thus even with the correct decryption algorithm for the encrypted true data, the true data will not be exposed by running a proper decryption over all of the data. In fact, by attempting to decrypt the entirety of data with the right decryption algorithm and that decryption not working, it appears the wrong decryption algorithm was used and a potential hacker would be encouraged to try another decryption algorithm as opposed to knowing the failed decryption attempt actually correctly applies to a secret subset of the data. In some embodiments, data transformation could be negotiated or agreed upon between the devices 10 and 20 over a first secure channel 40 or 50 in the network generation in block 130 while other embodiments may determine data transformations at other stages of method 100. The null data may be any set of data, including null data sets that closely resemble the true data being obscured by the null data. For example, some null data may be a 0 bit entered into many places in a data communication, or the null data may be a range of characters similar to any other true character sent in the data communication, as explained below in more detail in multilayered embodiments.

Some embodiments may provide additional security over a secure peer-to-peer connection 90 by use of a matrix transformation. For example, multiple devices 10 and 20 may decide on an encryption process utilizing a matrix or vector comprising a list of 1s and 0s, where the 1s may indicate true data and the 0s represent null data. The null data may be a string of garbage data generated by each peer, or the peers may determine a transmission ratio comprising an amount of true data in relation to an amount of null data. A matrix transformation to be used over secure peer-to-peer connection 90 may be negotiated or exchanged between devices 10 and 20 during the network establishment phase over first secure connection 40 or 50.

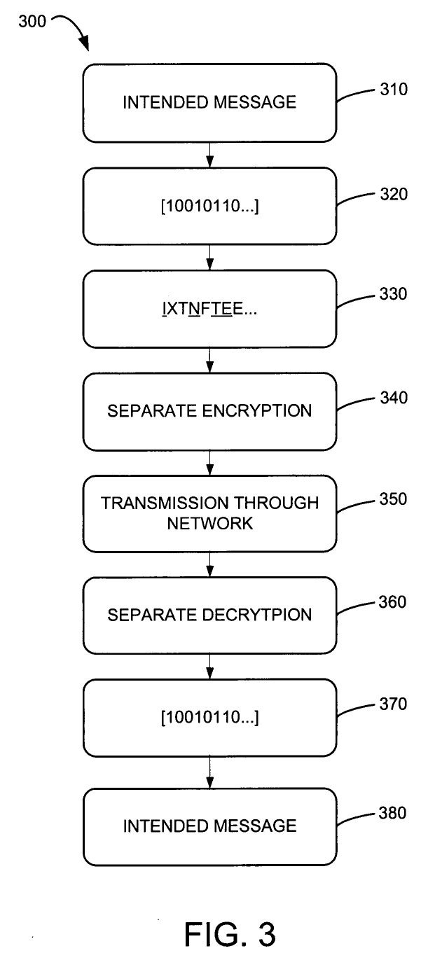

FIG. 3 is flow diagram illustrating a matrix transformation 300. The example matrix transformation 300 in FIG. 3 starts with an “intended message” in block 310 and applies a column vector matrix [10010110 . . . ] to the intended message in block 320. A column vector is illustrated in matrix transformation 300, but other matrix dimensions may be used. In some embodiments, the vector matrix may also rearrange the message [20030140 . . . ] where the actual message is the expected sequence of numbers 1, 2, 3, 4. According to the present example, each 1 in the matrix designates a portion of the intended message and a zero designates a null value. Therefore, the first character in the intended message, an “I”, is inserted in the place of the first 1 in the matrix, and a null or false value is inserted in the place of the next two values which are both 0 values in the column vector. Block 330 illustrates a partial column vector transformation to obscure the intended message in a larger set of data.

The column vector, or other matrix, may be negotiated or exchanged over a first secure connection 40 or 50 in FIG. 2, and then the matrix transformation 300 can occur over a separate channel such as peer-to-peer connection 90, and a sending device 10 and a receiving device 20 would use the column vector in 320 to obscure and extract the intended message from a larger obscured transmission.

In the example matrix transformation 300, a separate encryption process is illustrated in block 340, followed by transmission of the transformed and encrypted message through a network in block 350, and then the corresponding separate decryption of the transformed message in block 360. At this point a receiving device 20 may then use a decryption transformation matrix 370. To continue with the present embodiment, a decryption transformation matrix has a 1 where there is real data and a zero where false data is expected. When data is communicated through the network and received at the second device, the false data is dropped, and the remaining data can be decrypted by the protocol or program that has originally encrypted the data, thus exposing the secure communication.

In some embodiments, two devices can adjust the transformation over time to provide additional security. In this manner, by increasing the ratio of null data to true data, or by changing the position of null data and true data, a greater amount of security is provided. In some embodiments, null data may be added prior to a separate encryption operation and extracted after decryption by a receiving device as illustrated in matrix transformation 300. In other embodiments, null data may be inserted after the separate encryption in block 340 and extracted before the corresponding separate decryption illustrated in block 360 by a receiving device. According to another embodiment, block 340 may occur after block 310 and a first encryption can occur prior to stenographic manipulations. In this manner, the first decryption would also occur after the decryption transformation matrix is applied.

Since embodiments may use multiple peer-to-peer networks that can be managed individually, the present approach provides a flexible solution that further allows changing each peer-to-peer secure network independently and thus increasing security and privacy, yet still be relatively easy to configure and manage. Therefore, by securely establishing a peer-to-peer network over first secure connection 40 that combines multiple security approaches, each peer-to-peer network 90 can be independently managed.

Independent management of each peer-to-peer network 90 does not broadly disclose the encryption standard for all the devices signing into an access point. For example, in current networks, a class of users are given network characteristics so they can log securely into a network, but since each user or device is given the same network characteristics, the security is somewhat weakened between users of the same network. By independently managing security information in a peer-to-peer approach, other users of the same network will be as unaware of a separate users network characteristics as would be a person not on the network at all. This approach therefore improves the security between multiple users of the similar access points.

Additionally, independent management of each peer-to-peer network 90 is particularly suited to other peer-to-peer applications such as email, internet relay chat (IRC), collaboration software, etc. Example embodiments may operate on devices other than computers such as routers, printers, storage devices, cell phones, personal data assistants (PDAs), wireless access points, USB hubs, or similar other network capable devices.

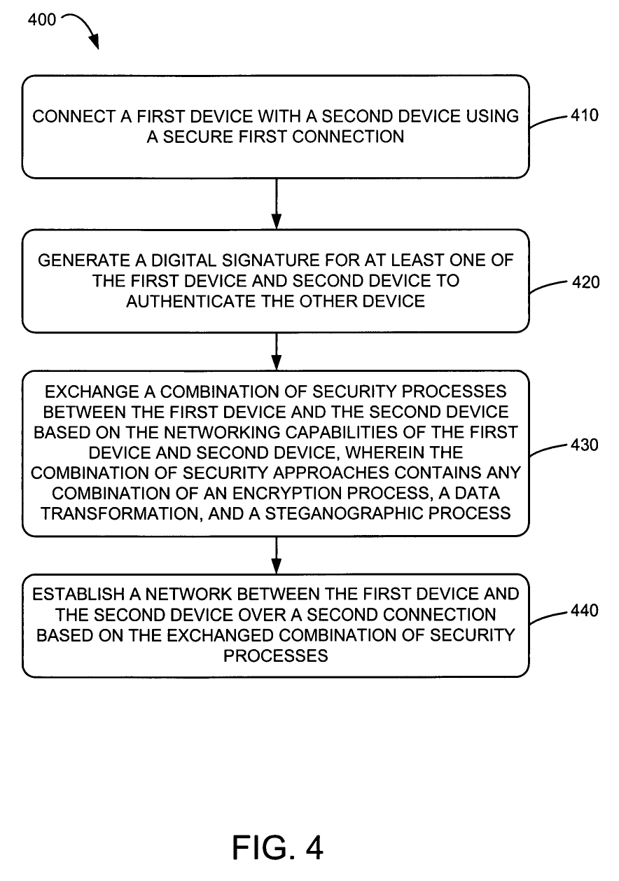

FIG. 4 is a flow diagram illustrating a multilayered approach to network security. According to block 410, method 400 can connect a first device with a second device using a secure first connection 40 or 50. During network establishment, devices may operate in a host/client relationship, in a peer-to-peer relationship, etc., but are not restricted to a particular relationship. Secure first connections 40 may include direct hard wired connections such as a USB cord connection, or a direct wired network connection; a direct line of site connection such as through infrared ports; or third-party authenticating devices such as a USB key, Smart Card, or a SIM card, as examples. In embodiments where two devices operate in a peer-to-peer relationship, a client may be installed on either device to allow method 400 to establish a secure peer-to-peer network 90. Furthermore, these embodiments may exchange an encrypted signature to allow each device to communicate with the other peer. In host/client embodiments, the host may pass an encrypted connection string to the client device, which the client device could use to connect and authenticate with the host.

In block 420, method 400 then can generate a digital signature for at least one of the first device and second device to authenticate the other device. The first and second device can also negotiate a combination of security processes between the first device and the second device based on the networking capabilities of the first device and second device, as shown in block 430. In some embodiments, the network characteristics may contain any combination of an encryption process, a data transformation, and a steganographic process, or a combination of any other known or to later developed security technologies. In embodiments using a third-party device, a pre-negotiated network may be used where a second device would have the choice to either accept or reject as opposed to negotiating network characteristics. In block 440, the method can establish a network between the first device and the second device over a second connection based on the exchanged combination of security processes. Some embodiments may comprise operating a network that was established in the manner of method 400.

A multilayered approach to network security may encapsulate multiple forms of encryption, data transformations, and null data in a combined approach to provide secure peer-to-peer networks 90. For example, the encryption may be a combination of multiple encryption algorithms. Another multilayered embodiment may provide an encryption mechanism, a data cipher and/or a data manipulation in combination to provide a secure network. This provides an additional benefit in that a multilayered approach may operate at higher levels of the protocol stack, such as at the application layer, wherein protection can be provided to users independent of their network access points.

As introduced above with reference to FIG. 2, a multilayered approach can be implemented in a host and client relationship. For example, a host device may operate as a server of peer-to-peer networks 90 and can therefore allow other devices to connect securely over a network. Communications that may provide limited amounts of security including instant messaging, video conferences, email, voice conferencing, point-to-point voice over internet protocol (VoIP) communications, etc., can be securely sent through a multilayered approach.

In some embodiments, a host device may operate as a gateway device, whereby a first device may gain network access by connecting to and exchanging credentials with a multilayered peer device 10 that is connected to a wireless network. In this way, the peer device 10 could continue to provide a connection to the wireless network. Once configured by a peer device, the first device can operate with a unique session over a wireless network that is distinct from other peer-to-peer networks 90 on the same wireless network. In some host and client multilayered embodiments, example clients may be computers running software enabling a multilayered interaction with the host device, a networked device designed to create a single network connection with another gateway or client device, etc.

Secondary forms of authentication can also be used that are not stored locally on a device/computer, allowing users and administrators the ability to control wireless access and create uniquely secure peer-to-peer connections 90 over the wireless network. In some embodiments, secondary forms of authentication can be used to administer passing of any network characteristics that are used to establish a multilayered approach to network security. A multilayered approach to network security therefore can create networks that are uniquely defined between two devices and can change over time, simplifying network generation and management for a network provider while also being able to provide a meaningful level of security for end users or between devices. Embodiments utilizing a multilayered approach are more fully explained in the following paragraphs.

An example multilayered embodiment may comprise various components including packet distribution, encryption, information transformation, disinformation, transmission and deciphering components. In this embodiment, the packet distribution component can provide filtering on a packet level. For example, packets according to one protocol can be encrypted and decrypted in the same or a different way than packets of another protocol. In another embodiment, data from certain ports may be encrypted and decrypted in a separate fashion than packets from different ports. In these examples, each port or each packet stream can be configured with unique multilayered characteristics and managed as parts of unique peer-to-peer networks 90.

Example multilayered characteristics to manage each unique peer-to-peer network 90 include protecting all ports or traffic, providing a general acceptance protection, providing a port or traffic specific protection, etc. If all ports or traffic protection is provided, all ports and traffic passed over the protected connection use some form of multilayered protection, for example, according to how protection is configured at a port level. In a general acceptance protection approach, specific ports that are designated as accepted or trusted encrypted ports may not be required to be encrypted. In a port specific protection scheme, the multilayered security may be limited to only certain types of ports. For example, a multilayered approach may be used to protect a print server by only applying multilayered security to protect ports utilized by a printer. In another example, a web only multilayered security approach may be used to protect only hypertext transfer protocol (HTTP) or secure HTTP (HTTPS) ports and traffic sent through other ports can be treated separately, such as left unencrypted, encrypted with a different encryption algorithm, blocked, etc.

The encryption component in a multilayered approach may utilize any encryption algorithm. The encryption type and configuration may be established and transferred from a host to a client device prior to establishing a multilayered session. In another embodiment, peer-to-peer devices may negotiate between mutually associated algorithms and establish a multilayered security session based on the negotiated algorithm.

The information transformation component can be represented as a subset embodiment of the null data example above. The information transformation component introduces spaces between data whereby the spaces can be filled later with disinformation or null data. For example, the character string 12345678 may can be expanded to 1002034000500006007000800 by inserting the 0 character spaces into the original string. In another embodiment, the information transformation component may rearrange the order of the information. For example, 12345678 can be rearranged to 62431857 and then spaces introduced to the data to generate 6002043000100008005000700. The information transformation component may also use any matrix transformation of data defined between two devices before use of the information transformation.

The disinformation component of the present embodiment multilayered approach inserts data into the spaces generated by the information transformation component. In some embodiments, the disinformation component can be adjusted over time according to information that is not to be used. As an example, disinformation may involve inserting a string encrypted by a similar process as true data and inserted into the spaces generated by the transformation component. In another embodiment, the disinformation may be a string encrypted under a different encryption scheme. For example, the encryption scheme may utilize the same encryption strength but a different encryption key, a different key and different encryption strength, random data that is not encrypted, a combination of various other disinformation strings, etc. In some embodiments, various characteristics such as encryption scheme can be changed during the course of operation of the multilayered secure network.

In the transmission component, data may be sent over any type of network, such as a TCP/IP network, any wired or wireless networks, etc. Additionally, the transmission component may provide data compression and can further control which type of transmission should be compressed. For example, in a wireless network there may be bandwidth restrictions on the transmitted data and therefore the transmission component can compress data over this type of connection.

In some embodiments, a deciphering component may be used that utilizes the method used by the transformation component and the method used by the encryption component. As data is received at a peer device, the peer device can then decipher the data stream. In this embodiment, if packets are lost, the deciphering component may request a resend of the packets according to an underlying protocol. For example, if the packets are lost, the deciphering component may request a resend before transmission control protocol (TCP) requests a resending of the data, and the resent data can therefore be treated as a new request for data.

In some embodiments, a multilayered approach may request a re-streaming and adjust any combination of these components be changed and a new characteristics applied to the communication between devices.

A multilayered approach may be generated by establishing a communication channel between two devices, determining that the communication channel provides a sufficient level of security, establishing the multilayered approach over the communications channel determined to provide sufficient security, and activating the multilayered approach. In some embodiments, multiple communication channels may be selected, and the multilayered approach may decide which communication channel to establish a connection over according to characteristics of the communications channels. In some embodiments, a secure connection can be maintained after it is established, even if a portion or all of the physical network connecting the devices is changed or an entirely new network is used.

In some embodiments, the channel that is used to establish the secure network may provide a lower level of security than the resulting network. For example, when a communication channel is used to establish the peer-to-peer secure network 90, the communication channel can be a direct connection or an otherwise secured connection. Direct connection examples include USB, Ethernet, serial and parallel ports, etc. Otherwise secured connections may use secure sockets layer (SSL), etc. After the establishing channel is determined to be sufficiently secure, the multilayered network characteristics can be exchanged, negotiated, transferred, etc. between the devices that will function as the peer-to-peer secure network 90.

Multilayered embodiments may be generated between peers based on capabilities and permissions. During network establishment, a device may search for a host or peer device based on either or both devices capabilities. In an example, a client device may search for a viable host which it can connect with, where a viable host is determined by the security capabilities of the host. Similarly, an open peer might accept a connection with any device capable of establishing a multilayered secure network as disclosed herein, while a protected peer might require usernames, passwords, or other types of authentication before establishing a multilayered secure network.

FIG. 5 is a block diagram of a device 500 as may be utilized in some embodiments. Embodiments are not limited to a single computing environment. Moreover, the architecture and functionality of embodiments as taught herein and as would be understood by one skilled in the art is extensible to other types of computing environments and embodiments in keeping with the scope and spirit of this disclosure. Embodiments provide for various methods, computer-readable mediums containing computer-executable instructions, and apparatus. With this in mind, the embodiments discussed herein should not be taken as limiting the scope of this disclosure; rather, this disclosure contemplates all embodiments as may come within the scope of the appended claims.

Embodiments include various operations, which will be described below. The operations, may be performed by hard-wired hardware, or may be embodied in machine-executable instructions that may be used to cause a general purpose or special purpose processor, or logic circuits programmed with the instructions to perform the operations. Alternatively, the operations may be performed by any combination of hard-wired hardware, and software driven hardware. Embodiments may be provided as a computer program that may include a machine-readable medium, stored thereon instructions, which may be used to program a computer (or other programmable devices) to perform a series of operations according to embodiments of this disclosure and their equivalents. The machine-readable medium may include, but is not limited to, floppy diskettes, optical disks, CD-ROM's, DVD's, magno-optical disks, ROM's, RAM's, EPROM's, EEPROM's, flash memory, hard drives, magnetic or optical cards, or any other medium suitable for storing electronic instructions. Moreover, embodiments may also be downloaded as a computer software product, wherein the software may be transferred between programmable devices by data signals in a carrier wave or other propagation medium via a communication link (e.g. a modem or a network connection).

Exemplary device 500 may implement an apparatus comprising a machine-readable medium to contain instructions that, when executed, cause the device 500 to connect to a second device using a secure first connection, generate a digital signature for at least one of the device 500 and second device to authenticate the other device, negotiate network characteristics between the device 500 and the second device based on the networking capabilities of device 500 and the second device, wherein the network characteristics contain at least one of an encryption type, an encryption key, a service set identifier and a network channel, and establish a network between device 500 and the second device over a second connection based on the negotiated network characteristics.

In the embodiment illustrated in FIG. 5, device 500 may comprise a bus or other communication means 501 for communicating information, and a processing means such as processor 502 coupled with bus 501 for processing information. Device 500 further comprises a random access memory (RAM) or other dynamically-generated storage device 504 (referred to as main memory), coupled to bus 501 for storing information and instructions to be executed by processor 502. Main memory 504 also may be used for storing temporary variables or other intermediate information during execution of instructions by processor 502.

Device 500 also comprises a read only memory (ROM) and/or other static storage device 506 coupled to bus 501 for storing static information and instructions for processor 502. A data storage device 507 such as a magnetic disk or optical disk and its corresponding drive may also be coupled to device 500 for storing information and instructions. Device 500 can also be coupled via bus 501 to a display device 521, such as a cathode ray tube (CRT) or Liquid Crystal Display (LCD), for displaying information to an end user. Typically, an alphanumeric input device (keyboard) 522, including alphanumeric and other keys, may be coupled to bus 501 for communicating information and/or command selections to processor 502. Another type of user input device is cursor control 523, such as a mouse, a trackball, or cursor direction keys for communicating direction information and command selections to processor 502 and for controlling cursor movement on display 521.

Some embodiments may have detachable interfaces such as display 521, keyboard 522, cursor control device 523, and input/output device 522 or may only use a portion of the detachable devices. An input/output device 525 is also coupled to bus 501. The input/output device 525 may include interrupts, ports, modem, a network interface card, or other well-known interface devices, such as those used for coupling to Ethernet, token ring, or other types of physical, wireless, and infrared or other electromagnetic mediums for purposes of providing a communication link. In this manner, the device 500 may be networked with a number of clients, servers, or other information devices.

It is appreciated that a lesser or more equipped computer system than the example described above may be desirable for certain implementations. Therefore, the configuration of device 500 will vary from implementation to implementation depending upon numerous factors, such as price constraints, performance requirements, technological improvements, and/or other circumstances.

Although a programmed processor, such as processor 502 may perform the operations described herein, in alternative embodiments, the operations may be fully or partially implemented by any programmable or hard coded logic, such as Field Programmable Gate Arrays (FPGAs), TTL logic, or Application Specific Integrated Circuits (ASICs), for example. Additionally, the method of the present embodiment may be performed by any combination of programmed general-purpose computer components and/or custom hardware components. Therefore, nothing disclosed herein should be construed as limiting this disclosure to a particular embodiment wherein the recited operations are performed by a specific combination of hardware components.

Note that the example network establishment and operation routines included herein can be used with various network configurations. The specific routines described herein may represent one or more of any number of processing strategies such as event-driven, interrupt-driven, multi-tasking, multi-threading, and the like. As such, various steps, operations, actions, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, steps, or functions may be repeatedly performed depending on the particular strategy being used. Further, the described steps or actions may graphically represent code to be programmed into a computer readable storage medium in a network device.

It will be appreciated that the configurations and routines disclosed herein are exemplary in nature, and that these specific embodiments are not to be considered in a limiting sense, because numerous variations are possible. For example, the above technology can be applied to wireless networks, wired networks, peer-to-peer networks, and other network types. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

We claim:

1. A method for establishing a peer-to-peer network, comprising:
connecting a first device with a second device using a secure first connection;
generating a digital signature for at least one of the first device and second device to authenticate the other device;
negotiating network characteristics between the first device and the second device based on the networking capabilities of the first device and second device, wherein the network characteristics contain at least one of an encryption type, an encryption key, a service set identifier and a network channel; and
establishing a network between the first device and the second device over a second connection based on the negotiated network characteristics.

2. The method of claim 1, wherein the secure first connection is a direct hard wired connection, a direct line of sight connection, or a removable authenticating device connection.

3. The method of claim 1, wherein if the first device and second device operate as a host and a client, the host device configures the network characteristics and provides a password for the client device to use to connect to the network.

4. The method of claim 1, further comprising establishing a second peer-to-peer network between the first device and a third device, wherein the second peer-to-peer network negotiates and uses a different set of network characteristics.

5. The method of claim 1, wherein the first device and second device are connected using the first secure connection only while authenticating each other.

6. The method of claim 5, further comprising negotiating a new set of network characteristics between the first device and the second device based on the networking capabilities of the first device and second device, wherein the network characteristics contain at least one of an encryption type, an encryption key, a service set identifier and a network channel.

7. The system of claim 1, further comprising generating a transform to add null data to communications between the first device and the second device over the second connection, wherein upon receipt of these communications, the second device strips the null data and processes the communication according to the negotiated network characteristics.

8. A first network capable device comprising:
a first communication link to provide a secure connection with a second device; and
a processor coupled with the first communication link, the processor to:
generate a digital signature for the second device to authenticate the first network capable device;
negotiate network characteristics with the second device based on the networking capabilities of the two devices, wherein the network characteristics contain at least one of an encryption type, an encryption key, a service set identifier and a network channel; and
establish a network between the devices over a second communication link coupled with the processor, wherein the network between the devices is configured based on the negotiated network characteristics.

9. The device of claim 8, wherein the secure first communication link is a direct hard wired connection, a direct line of sight connection, or a removable authenticating device communication link.

10. The device of claim 8, wherein if the first device and second device operate as a host and a client, the host device configures the network characteristics and provides a password for the client device to use to connect to the network.

11. The device of claim 8, further comprising a second peer-to-peer network between the first device and a third device, wherein the second peer-to-peer network negotiates and uses a different set of network characteristics.

12. The device of claim 8, wherein the first device and second device are connected using the first communication link only while authenticating each other.

13. The device of claim 8, further comprising the processor to negotiate a new set of network characteristics between the first device and the second device based on the networking capabilities of the first device and second device, wherein the network characteristics contain at least one of an encryption type, an encryption key, a service set identifier and a network channel.

14. The device of claim 8, further comprising the processor to generate a transform to add null data to communications between the first device and the second device over the second communication link, wherein upon receipt of these communications, the second device strips the null data and processes the communication according to the negotiated network characteristics.

15. A machine-readable medium having stored thereon sequences of instructions, comprising:
code to transmit information between a first device and a second device using a secure first connection;
code to generate a digital signature for at least one of the first device and second device to authenticate the other device;
code to negotiate network characteristics between the first device and the second device over the first connection based on the networking capabilities of the first device and second device, wherein the network characteristics contain at least one of an encryption type, an encryption key, a service set identifier and a network channel; and
code to establish a network between the first device and the second device over a second connection based on the negotiated network characteristics and based on successful authentication.

16. The medium of claim 15, wherein the secure first connection is a direct hard wired connection, a direct line of sight connection, or a removable authenticating device connection.

17. The medium of claim 15, wherein if the first device and second device operate as a host and a client, the host device configures the network characteristics and provides a password for the client device to use to connect to the network.

18. The medium of claim 15, further comprising instructions for establishing a second peer-to-peer network between the first device and a third device, wherein the second peer-to-peer network negotiates and uses a different set of network characteristics.

19. The medium of claim 18, wherein the first device and second device are connected using the first secure connection only while authenticating each other.

20. The medium of claim 15, further comprising instructions for negotiating a new set of network characteristics between the first device and the second device based on the networking capabilities of the first device and second device, wherein the network characteristics contain at least one of an encryption type, an encryption key, a service set identifier and a network channel.

21. The medium of claim 15, further comprising instructions for generating a transform to add null data to communications between the first device and the second device over the second connection, wherein upon receipt of these communications, the second device strips the null data and processes the communication according to the negotiated network characteristics.

22. A method for establishing a peer-to-peer network, comprising:
connecting a first device with a second device using a secure first connection;
generating a digital signature for at least one of the first device and second device to authenticate the other device;
negotiating a combination of security processes between the first device and the second device based on the networking capabilities of the first device and second device, wherein the combination of security approaches contains any combination of an encryption process, a data transformation, and a steganographic process; and
establishing a network between the first device and the second device over a second connection based on the exchanged combination of security processes.

23. The method of claim 22, wherein the secure first connection is a direct hard wired connection, a direct line of sight connection, or a removable authenticating device connection.

24. The method of claim 22, wherein if the first device and second device operate as a host and a client, the host device configures the combination of security processes and provides a password for the client device to use to connect to the network.

25. The method of claim 22, further comprising establishing a second peer-to-peer network between the first device and a third device, wherein the second peer-to-peer network negotiates and uses a different set of network characteristics.

26. The method of claim 22, wherein the first device and second device are connected using the first secure connection only while authenticating each other.
